(19) United States
(12) Patent Application Publication
(10) Pub. No.: US 2009/0248410 A1
(43) Pub. Date: Oct. 1, 2009

(54) LIGHTED TEXT DISPLAY FOR MOTOR VEHICLES

(76) Inventor: Steve Wingard, Round Rock, TX (US)

Correspondence Address: ANDREW G. DINOVO;DiNOVO PRICE ELLWANGER & HARDY LLP, 7000 N. MOPAC EXPRESSWAY, SUITE 350, AUSTIN, TX, 78731, US

(21) Appl. No.: 12/058,217

(22) Filed: Mar. 28, 2008

(51) Int. Cl. G10L 15/26; G09G 3/00

(52) U.S. Cl. 704/235; 345/30; 704/E15.043

(57) ABSTRACT

A system and method are disclosed enabling drivers of a vehicle to enter, edit and post messages on a graphical display attached to the interior or exterior of a vehicle. Voice recognition software allows the driver of the vehicle to input, and the system to display, a message without the need for diverting his or her attention from the road or otherwise manually interacting with the system.

### FIELD OF THE INVENTION

The present invention relates generally to the field of automobiles, and more particularly to signage and display systems for automobiles and other vehicles.

### BACKGROUND OF THE INVENTION

The automobile is ubiquitous in American society. Because of its pervasiveness, it is well suited as a communications medium. In the past, taxicabs and other vehicles have carried placards on their vehicles. Others have painted their vehicles with messages or placed stickers on their vehicles. Still others carry signage on the top of their vehicles or in another location.

Despite certain advantages of the foregoing, the prior art methods suffer from certain shortcomings. The communicated message in such prior art media are static, and must be changed by physically removing or covering the object or objects conveying the message. It cannot be changed “on the fly,” by the driver or any other person. Moreover, coordination of multiple such systems is cumbersome, and requires physical access to all related vehicles.

In view of the foregoing, a system and method are needed for improved entry, control and display of communications from a vehicle.

### SUMMARY OF THE INVENTION

Embodiments of the system and method of the present invention allow drivers of a vehicle to enter, edit and post messages on a display which may be attached to the interior or exterior of a vehicle. Voice recognition may be incorporated so that the driver of the vehicle can display a message without the need for diverting his or her attention from the road or manually interacting with the system.

In an alternative embodiment, the system in each vehicle is equipped with a wireless transceiver, such as a cell phone communication system, and may be remotely programmed from a central hub via a wireless communications system.

### BRIEF DESCRIPTION OF THE DRAWINGS

The foregoing and other advantages of the invention will become apparent upon reading the following detailed description and upon reference to the drawings, wherein:

FIG. 1 is a block diagram of an illustrative embodiment of the present invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DESCRIPTION OF PREFERRED EMBODIMENTS

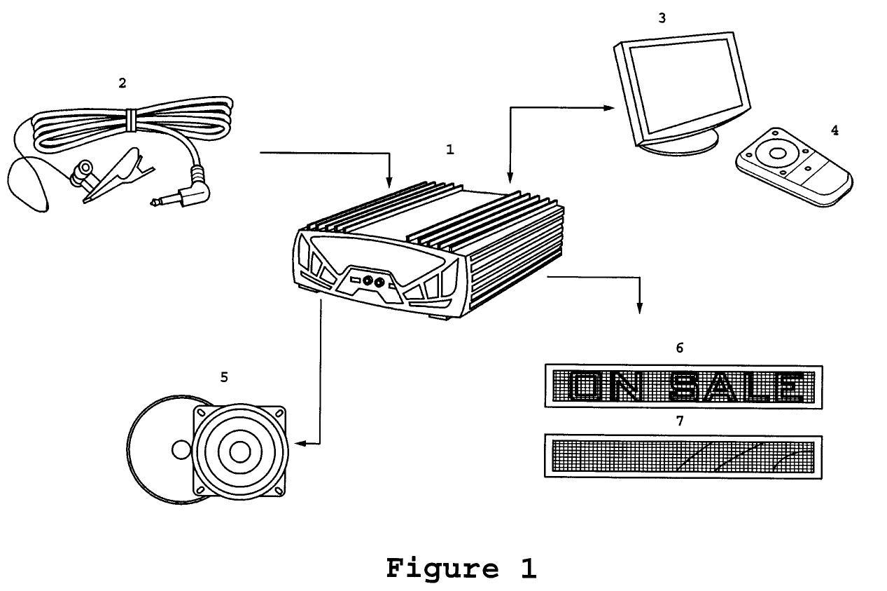

FIG. 1 depicts in block diagram format a preferred embodiment of the present invention. Persons of ordinary skill in the art will appreciate that the invention can also be applied with other configurations, including elimination of some of the components illustrated in the FIGURE.

Still referring to FIG. 1, automotive computer system 1 contains a central processing unit and memory (not shown), and coordinates the communications between the other system components. Automotive computer system 1 may be combined with other computing functions, such as a navigation system or embedded computer system. Microphone 2 may be clipped or otherwise attached to a user of the system, and may be either wired or wireless. In an alternative embodiment, the microphone is fixedly attached to the vehicle. Microphone 2 allows the user to interact with the system through voice commands and voice recognition software.

Touchscreen 3 may alternatively be used to enter commands by the user and display information to the user, including options for display and the current display. In a preferred embodiment, the user may enter new messages using a keyboard, keypad or other user-input device, including for example remote handheld 4. Alternatively, the user may select from a number of messages that have been stored in memory, and that may have been previously downloaded or transmitted through wireless communication channels.

Still referring to FIG. 1, speakers 5 may be deployed to allow audible interaction with and feedback from automotive computer 1. In one embodiment, the main audio system of the vehicle provides the speaker functionality for the system of the present invention.

A display panel is embedded with illuminating pixels such as light emitting diodes (LEDs). The panel can be made to adhere magnetically to the metal surface of a motor vehicle or can be permanently mounted on special brackets. In a preferred embodiment, the display panel comprises magnetized rubber, which can be detachably connected to the vehicle without damaging the vehicle's exterior.

In addition to LEDs, other display technologies may be used, including LCD and plasma. In one embodiment, flexible LCD is used, which may be advantageously flexed to connect to various locations on a vehicle.

One or more display panels 6 can be connected to computer 1, which can be housed in the passenger compartment of the vehicle, or in another portion of the vehicle, such as within the frame of the vehicle, under the hood or in the trunk.

The connection between computer 1 and display panel 6 can be wired or wireless. In a preferred embodiment, the display panel 6 communicates wirelessly with the computer 1 so that the display panel 6 is more readily mobile and may be relocated in various positions on the vehicle.

In a preferred embodiment, a user input device is provided which functions as a combination microphone/key pad, communicates with the computer and is used to generate a text message. In any case, the user input device may communicate with the computer either wirelessly or by wire.

In an alternate embodiment, a central input device communicates with a plurality of computers within a plurality of vehicles. In this way, from a centralized or remote location, the computers and displays of many vehicles may be controlled and the displays coordinated. In various situations, it may be advantageous for many vehicles to display the same text message (e.g., advertisements) or different text messages, or graphics, or a combination thereof.

The system can be powered by the vehicle electrical system accessed through the auxiliary power outlet or cigarette lighter. Alternatively or additionally, the system is powered by battery or through special connection the vehicle electrical system.

Embodiments of the invention function as follows. The invention can be voice activated, in that words spoken into the microphone are converted by the computer into electrical signals using voice recognition software. The words are then caused to appear on the display panel by the computer. The key pad can be programmed to function directly to generate a text message.

In one embodiment, the computer is coupled to storage, so that various messages, advertisements or other content (text or graphics) can be accessed for display.

The computer sends the electrical signals to the display panel, lighting diodes in proper sequence thus causing either a scrolling or static text to appear at about the speed it is spoken or typed.

When speech is halted, the last text repeats until it is interrupted by a command button on the computer or until a new text is sent.

For monitoring purposes, the computer may be provided with a digital display which can display the text seen outside the vehicle, and enable other user functions such as retrieval of stored messages.

In a preferred embodiment, system control is achieved via an automotive PC. Voice recognition is handled by a Java applet (or equivalent) running on the PC. The system can be Windows or Linux based. In the basic system additional multimedia features are possible, including DVD, MP3 and other video and audio formats, a touch panel to enter messages and control the system, and Bluetooth or other wireless communications capability.

Accordingly, in various alternative embodiments, the system of the present invention comprises the following features:
magnetized rubber display panel embedded with LEDs;
microphone/key pad;
central processing unit;
voice recognition software;
storage;
scrolling or static text message;
magnetic or mechanical attachment to vehicle;
portable or permanent attachment; and/or
powered by vehicle electrical system via auxiliary power outlet or cigarette lighter, other connection and/or battery.

As noted above, while the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

What is claimed is:

1. A system for displaying messages on a vehicle comprising:
an automotive computer system;
a microphone in communication with said computer system for inputting voice commands, wherein said automotive computer system receives said voice commands and interprets them into a digital message;
a programmable display panel in communication with said automotive computer system, whereby said automotive computer system is adapted to communicate said digital message to said programmable display panel, and said programmable display panel is adapted to responsively display said message.

2. The system of claim 1, wherein said microphone comprises a wireless transmitter.

3. The system of claim 2, wherein said automotive computer system comprises a wireless receiver.

4. The system of claim 1, wherein said automotive computer system comprises a wireless transceiver.

5. The system of claim 5, wherein said programmable display panel comprises a wireless receiver.

6. The system of claim 1, wherein said automotive computer system is integral to said programmable display panel.

7. The system of claim 1, wherein said automotive computer system comprises a microprocessor and memory.

8. The system of claim 7, wherein said automotive computer system runs a voice recognition software program.

9. The system of claim 1, further comprising a touch screen for inputting a set of commands to said automotive computer system.

10. A method of displaying a message on a vehicle, said method comprising:
attaching a programmable display to said vehicle so that said display is visible from an exterior position;
inputting a message to a computer located on said vehicle via voice recognition software;
transmitting said message from said computer to said display; and
displaying said message in response to said transmitting step.

11. The method of claim 10, wherein said inputting step comprises speaking into a microphone.

12. The method of claim 10, wherein said inputting step comprises wirelessly communicating the message to said computer.

13. The method of claim 10, wherein said computer comprises a wireless transceiver.

14. The method of claim 10, wherein said transmitting step comprises wireless transmission of said message.

15. The method of claim 10, further comprising inputting one or more commands to said computer using a touch screen.

16. The method of claim 10, wherein said attaching step comprises attaching to an exterior of said vehicle.

17. The method of claim 10, wherein said attaching step comprises attaching to an interior of said vehicle.

18. The method of claim 10, wherein said attaching step comprises attaching to a front of said vehicle.

19. The method of claim 18, wherein said message is displayed as a mirror image, so as to be readily interpreted by a second vehicle from a rear-view mirror of said second vehicle.
